(19) United States
(12) Patent Application Publication
(10) Pub. No.: US 2019/0104864 A1
(43) Pub. Date: Apr. 11, 2019

(54) INVENTORY MANAGEMENT SYSTEM FOR ALCOHOLIC BEVERAGES

(71) Applicant: BarLinQ LLC, Yardley, PA (US)

(72) Inventors: Alan Barnet, Mamaroneck, NY (US); Henry Ancker, Bethlehem, PA (US); David Garfield, Cumberland, ME (US)

(21) Appl. No.: 15/726,807

(22) Filed: Oct. 6, 2017

(51) Int. Cl. A47F 5/00; G06Q 10/08; G01G 19/414; A47F 10/06; G01G 19/20

(52) U.S. Cl. CPC A47F 5/0043; G06Q 10/087; G01G 19/20; A47F 10/06; G01G 19/4144

(57) ABSTRACT

A system and method for monitoring the amount of alcoholic beverages dispensed from bottles in a business establishment that serves alcoholic beverages. The system and method uses a pair of scales located on opposite ends of at least one shelf upon which are positioned bottles of alcoholic beverages. The scales detect changes in weight on the shelf and provide that data, along with calibration data, to a system database and a processor which analyzes all that data to detect a change of weight of the shelf as well as position on that shelf of where that change of weight occurred. A point of sale system of the business establishment is also in communication with the system database/processor so that change of weight data, position data and sales data can be analyzed to display revenue and cost data on a computer including a software application that configures the computer for displaying spreadsheets of all of this data.

### CROSS-REFERENCE TO RELATED APPLICATIONS

Not Applicable

### REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF THE INVENTION

The disclosed invention relates to inventory management systems, and more particularly to systems for monitoring the amount of alcoholic beverages dispensed from bottles or other vessels in a bar or other establishment serving alcoholic beverages.

### BACKGROUND OF THE INVENTION

With regard to alcoholic beverage sales at business establishments (e.g., bars, etc.) the current industry standard is to weigh the liquor bottles individually, eyeball the fill levels, measure the pour with a flow meter pour spout, or a liquor gun that dispenses a set amount. In particular, such manual systems provide accurate inventory count but are time intensive and only provide insight as to how much inventory has been lost over the period of time between inventory counts, without any understanding why the inventory was lost. Some real-time inventory systems make use of Wi-Fi pour spouts or individual connected scales. As should be appreciated, pour spouts are unsightly to customers and require cumbersome cleaning, recharging, or replacement as well as well as require extensive operator training to program each time the bottle is replaced, slowing the workflow. Individual scales are too expensive to be practical, do not allow for natural placement of bottles and do not necessarily fit all size bottles. Again, being visible to the customer is unsightly and bad for business.

Thus, there remains a need for a system and method of managing alcoholic beverage inventory/sales which have a low profile that is not noticed by the customer, which allow bottles to sit naturally next to each other rather than being spaced apart, does not interfere with the operator's workflow, and provides the most accurate insights into why inventory is not being optimized.

### SUMMARY OF THE INVENTION

In accordance with one aspect of this invention there is provided an alcoholic beverage inventory management system for use in a business establishment where alcoholic beverages are dispensed. The system comprises: at least one shelf upon which are positioned bottles or other vessels for holding alcoholic beverages, the shelf having two opposite ends and a respective scale positioned under each end, wherein each of the scales provides load data of the bottles or other vessels positioned on the at least one shelf to a base unit (e.g., a gateway) over a first communication system (e.g., Ethernet, Zigbee, Bluetooth, etc.); a system database for storing the load data received from the base unit; a processor in communication with the system database, wherein the processor analyzes the load data for determining the amount of liquor dispensed from respective bottles on the at least one shelf; a point of sale system associated with the business establishment which provides data related to the sale of alcoholic beverages in the business establishment to the system database for analysis by the processor; and a computer, comprising a software application, that is in communication with the processor, and wherein the computer displays data related to revenues and costs associated with the alcoholic beverages dispensed from the bottles or other vessels on the at least one shelf.

A method for managing alcoholic beverage inventory in a business establishment where alcoholic beverages are dispensed is disclosed. The method comprises positioning a scale under a respective end of at least one shelf upon which are placed bottles or other vessels for holding alcoholic beverages, and wherein each of the scales provides load data about the bottles or other vessels positioned on the at least one shelf to a base unit (e.g., a gateway) over a first communication system (e.g., Ethernet, Zigbee, Bluetooth, etc.); providing a system database for storing the load data received from the base unit and providing a processor in communication with the system database; analyzing the load data by the processor for determining the amount of alcoholic beverages dispensed from respective bottles on the at least one shelf; providing data, from a business establishment point of sale system, related to the sale of alcoholic beverages in the business establishment to the processor; and displaying, on a computer comprising a software application which is in communication with the processor, data related to revenues and costs associated with the alcoholic beverages dispensed from the bottles or other vessels on the at least one shelf.

### BRIEF DESCRIPTION OF THE DRAWING FIGURES

FIG. 1 is an illustration of one exemplary system for monitoring the inventory and dispensing of alcoholic beverages from respective bottles or vessels containing the same resting on shelves whose weights are monitored in accordance with this invention;

FIG. 1A is an alternative system of the present invention utilizing remotely-located processing (e.g., cloud-based computing);

FIG. 2 is an isometric view of one shelf forming a portion of the system shown in FIG. 1, the shelf including two scale assemblies, each of which is located at a respective end of the shelf;

FIG. 3 is an end elevation view of the shelf shown in FIG. 2 showing one of the two scale assemblies;

FIG. 4 is an enlarged isometric view of one of the scale assemblies of the shelf shown in FIG. 2, with a cover (not shown) removed, revealing a load cell sensor assembly including an integrated circuit board;

FIG. 5 is a somewhat reduced exploded isometric view of one scale assembly of FIG. 4 showing the load cell sensor assembly, the integrated circuit board and the cover;

FIG. 6 is an isometric view, similar to FIG. 4, but showing an alternative embodiment of a scale assembly constructed in accordance with this invention and with the cover removed;

FIG. 7 is a functional diagram of shelf assembly parameters used in determining the weight change and shelf position of the weight change and using a shelf length of 20 inches, by example only;

FIG. 8 is a display screen of the customer facing application (CFA) showing the gateway details;

FIGS. 9A-9B depict an exemplary CFA display screen (left-hand and right-hand sides, respectively) of a particular shelf within the establishment showing the various parameters of the shelf and the events occurring at that shelf over time;

FIGS. 10A-10B depict an exemplary CFA display screen (left-hand and right-hand sides, respectively) showing the roster of individual scale assemblies of all of the shelves within the establishment;

FIG. 11 depicts an exemplary CFA display screen of a particular shelf displaying particular parameters of that shelf and the corresponding Readings of its associated scales;

FIG. 12A depicts an exemplary partial CFA display screen that provides an inventory of the stockroom by color and a number;

FIG. 12B depicts an exemplary partial CFA display screen that provides the inventory of the bottles, by position, on each shelf in the establishment;

FIG. 13 is an exemplary dashboard display of the CFA that provides the establishment owner with the costs and revenues calculated by the system of the present invention;

FIG. 14 depicts an exemplary CFA bottle position assignment display that allows the establishment owner to assign a particular liquor bottle to a shelf position; and

FIGS. 15A-15B depict an exemplary CFA bottle trace screen (left-hand and right-hand sides, respectively) that shows how the change-in-weight value (μW) and the bottle position (X) whose weight was diminished through pouring are displayed in the present invention.

### DETAILED DESCRIPTION OF THE PREFERRED EMBODIMENTS

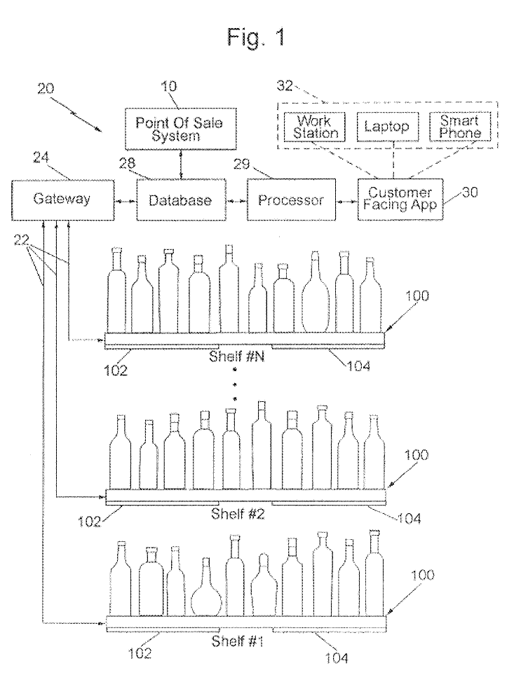

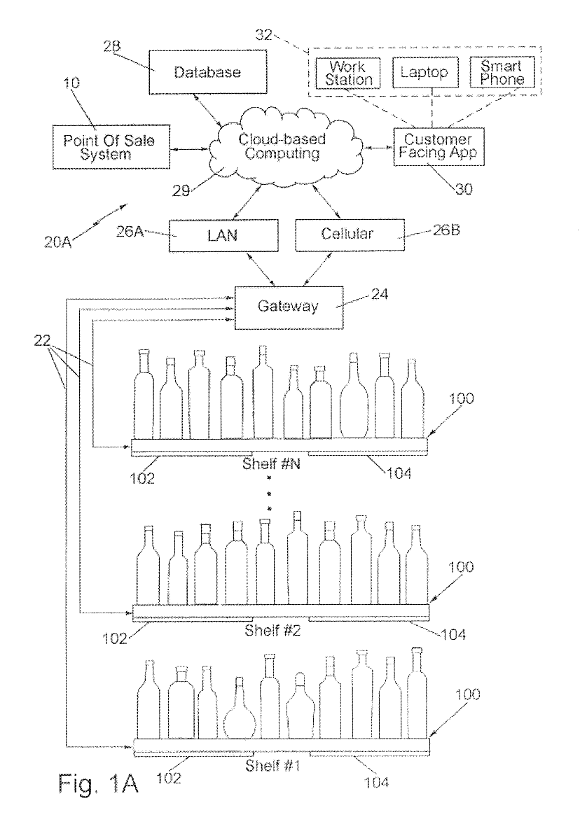

Referring now to the drawings wherein like characters refer to like parts there is shown in FIGS. 1-3 one exemplary embodiment of an inventory management system 20 constructed in accordance with this invention. The details of the system will be described shortly. Suffice it for now to state, that the system includes at least one shelf assembly, and preferably two scales, positioned at opposite ends of the shelf assembly. Each scale is in the form of a low profile assembly that makes use of two weight sensors (e.g., load cell sensors) positioned under, and at the end of, the shelf assembly. Each shelf assembly, and its respective scales, have unique identification information. Load sensor data, along with calibration data unique to that shelf assembly is provided to a processor (e.g., transmitted to cloud computing processing) which is then able to identify the location of a bottle that has been picked up and then restored to that shelf, in addition to determining the change of weight. This is an improvement over the current industry standard which is to weigh the bottles individually, eyeball the fill levels, measure the pour with a flow meter pour spout, or a liquor gun that dispenses a set amount. In contrast, the system of this invention provides numerous advantages over the prior art systems. In particular, manual systems provide accurate inventory count but are time intensive and only provide insight as to how much inventory has been lost over the period of time between inventory counts, without any understanding why the inventory was lost. Some real-time inventory systems make use of Wi-Fi pour spouts or individual connected scales. As should be appreciated, pour spouts are unsightly to customers and require cumbersome cleaning, recharging, or replacement as well as well as require extensive operator training to program each time the bottle is replaced, slowing the workflow. Individual scales are too expensive to be practical, do not allow for natural placement of bottles and do not necessarily fit all size bottles. Again, being visible to the customer is unsightly and bad for business. In contrast, the system of this invention has a low profile that is not noticed by the customer, allows bottles to sit naturally next to each other rather than being spaced apart, does not interfere with the operator's workflow, and provides the most accurate insights into why inventory is not being optimized.
The shelf assembly holds between 2 and n bottles.
There are load cells located at either end of the shelf assembly that provide data related to weight changes and unique calibration values for which bottle on the shelf was removed and diminished in its contents.
Data provided by the load cells to the processor allows for the determination of the location on the shelf assembly of a bottle that was picked up, its contents diminished including via a change in weight, and the time of this occurrence.
The system's database (cloud or locally based) includes the densities of different liquids, the location of each liquid, the number of bottles on each shelf assembly, the scales' unique calibration for each shelf, and the inventory of unopened bottles not on scales.
The system converts the change in weight to volume depending on what bottle was poured.
The volume poured is compared to the records of the Point of Sale System and the recipe for the drink sold to determine if the liquid dispensed was over poured, under poured, or not sold at all.
Although two scales per shelf assembly are shown, it is within the broadest scope of the invention to include a plurality of scales thereunder.
The scales may be “daisy-chained” into a network or each scale may comprise its own wireless transmitter for conveying its data wirelessly to a remotely-located gateway. In the latter, the data can be accessed locally or through a web application.
The scales may be powered by battery or plugged into a wall outlet.

As shown in FIG. 1, the overall system 20 comprises at least one shelf 100 (installed in a business establishment) that is in communication over a communication system 22 (wired or wireless) with a base unit 24 (e.g., a gateway). The base unit 24 communicates with a system database 28 and an associated processor 29. The point-of-sale (POS) system 10 of the business establishment is also in communication with the system database 28 and the processor 29 for providing sales data to the database 28/processor 29 for generating revenues and costs associated with change of weight of the bottles or other vessels containing alcoholic beverages as will be discussed in detail below. Finally, a customer facing application (CFA) 30 is installed on a computer 32 (e.g., laptop or workstation at the business establishment, smartphone, etc.) for displaying system 20 data, including among other things, the amount of fluid poured from bottles or vessels on the at least one shelf 100 as well as revenues (or losses) associated with the pouring from these bottles or vessels.

FIG. 1A depicts an alternative embodiment 20A for the processor 29 whereby a remotely-located processing function is used, such as cloud-based computing (CBC, e.g., Amazon's Elastic Compute Cloud, etc.). Where such CBC is used for the processor 29, a second communication system is used to convey the load data (as will also be discussed below) from the scales 102/104 to global computer networks (e.g., the Internet) where the CBC resides. In particular, this second communication system may comprise a local area network (LAN) 26A or a cellular network 26B to the system database 28 and associated cloud-based computing function 29 (e.g., Amazon's Elastic Compute Cloud, etc.)). Other than that, the system 20 and system 20A operate similarly.

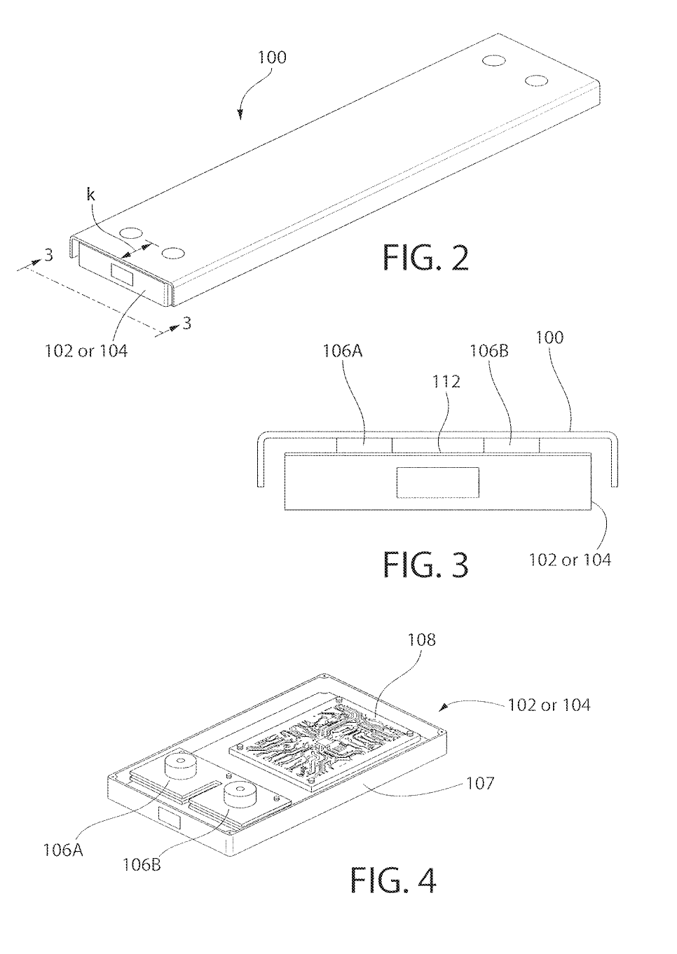

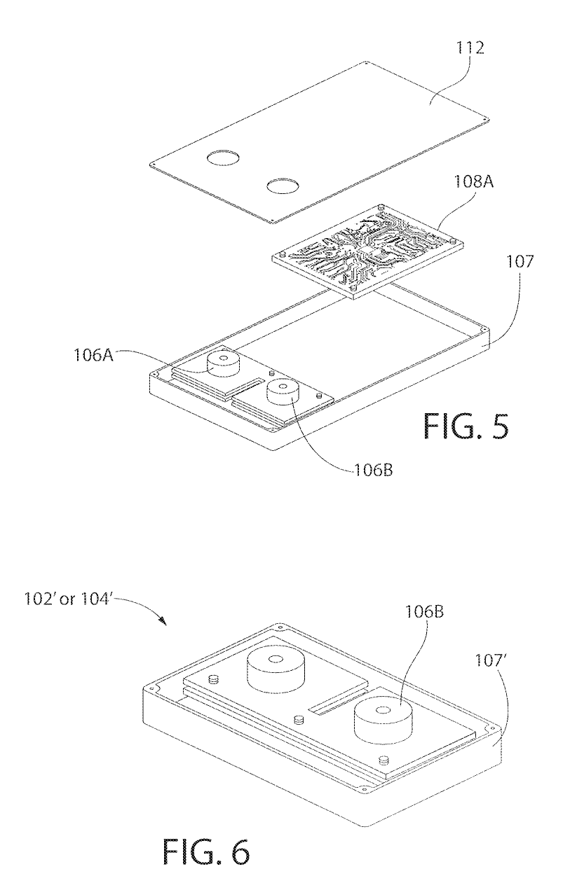

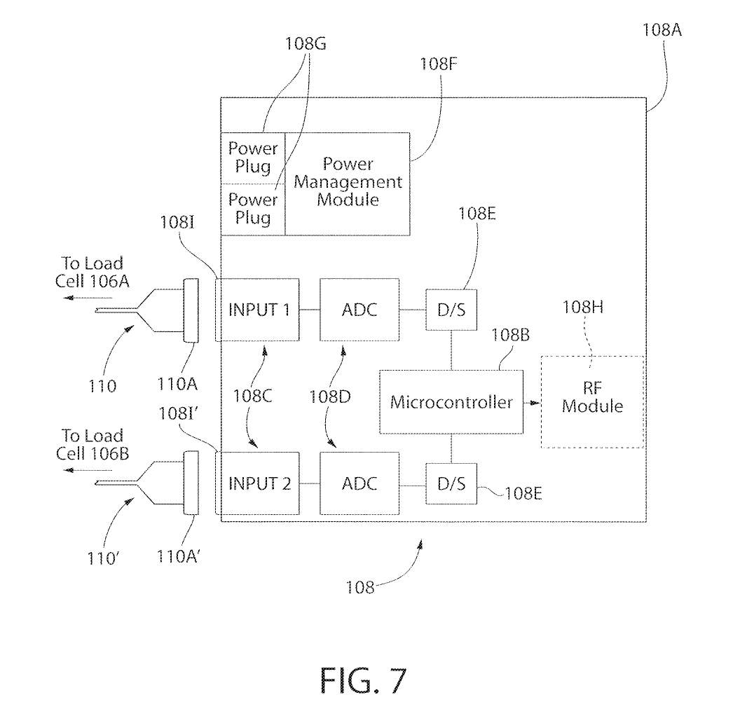

The shelf assembly 100 (FIG. 2) comprises two scale assemblies 102 and 104 (FIG. 4) releasably secured under each end of the shelf 100 (FIG. 1). As shown most clearly in FIG. 4, each scale assembly 102/104 comprises two load cells 106A/106B (e.g., planar beam load cells manufactured by Group Four Transducers, Inc.) that provide raw load data to an electronic interface 108 (e.g., a printed circuit board) via a cable harness 110 (FIG. 7). Each scale assembly 102/104 and shelf 100 has its own ID so that data from any particular scale assembly 102/104 can be attributed to a particular shelf and scale. The load cells 106A/106B are positioned within a base enclosure 107 (e.g., aluminum). A cover 112 (FIG. 3) includes two apertures 114 that allow the load mount 106A/106B to pass through when the cover 112 is installed. Power is provided to the power plugs 108G via a separate power harness (not shown) either from a wall outlet (not shown) or a battery (not shown).

FIG. 6 depicts an alternative configuration of the scale assembly 102 or 104. In particular, this scale assembly configuration 102′/104′ is smaller than scale assemblies 102/104 because the electronic interface 108 (viz., the circuit board 108A) would form a separate unit (not shown), as can be easily seen by the smaller base enclosure 107′. As such, instead of having a dedicated electronic interface 108 for each scale assembly 102/104, the output of each load cell pair 106A/106B would be fed to the separate electronic interface 108. By way of example only, the separate electronic interface 108 can be positioned between the two scale assemblies 102′/104′ underneath the shelf 100.

It should be noted that the communication system 22 with the electronic interface 108 may comprise either a “daisy-chain” of other scale assemblies 102/104 to the base unit 24 or gateway 24; or alternatively, each electronic interface 108 can include its own wireless interface (e.g., Zigbee, Bluetooth, etc.) for wirelessly transmitting its load cell data to the base unit 24. As a result, the scale assemblies 102/104 do not calculate weight changes based on the load data; rather, all of that load cell information is passed on, along with other related data (to be discussed below), to the base unit 24 that relays all of that information to the system database 29 for use by the processor 28. By way of example only, FIG. 7 depicts a block diagram of the electronic interface 108 which includes a circuit board 108A comprising a microcontroller 108B (e.g., Atmel Atmega microcontroller IC 8-bit 16 MHz 32 kB Flash), load cell inputs 108C, analog-to-digital converters (ADCs) 108D, digital switches 108E (e.g., Texas Instruments SN74LVC1G66DBVT IC switch), a power management module 108F having power plugs 108G (e.g., CUI Inc., PJ-002A CP-002A-ND CONN power jack) and an RF module 108H (where a wireless connection is used to communicate with the base unit 24 and which operates in the 900 MHz or 2.4 GHz frequency bands). The wire harnesses 110 and 110′ electrically connect the load cells 106A/106B, respectively, to the circuit board 108A via the mating of respective harness plugs 110A/110A′ to respective circuit board connectors 108I and 108I′. The load cells' 106A/106B data is processed such that that the raw data effectively represents a single load cell and wherein that data is then provided to the base unit 24.

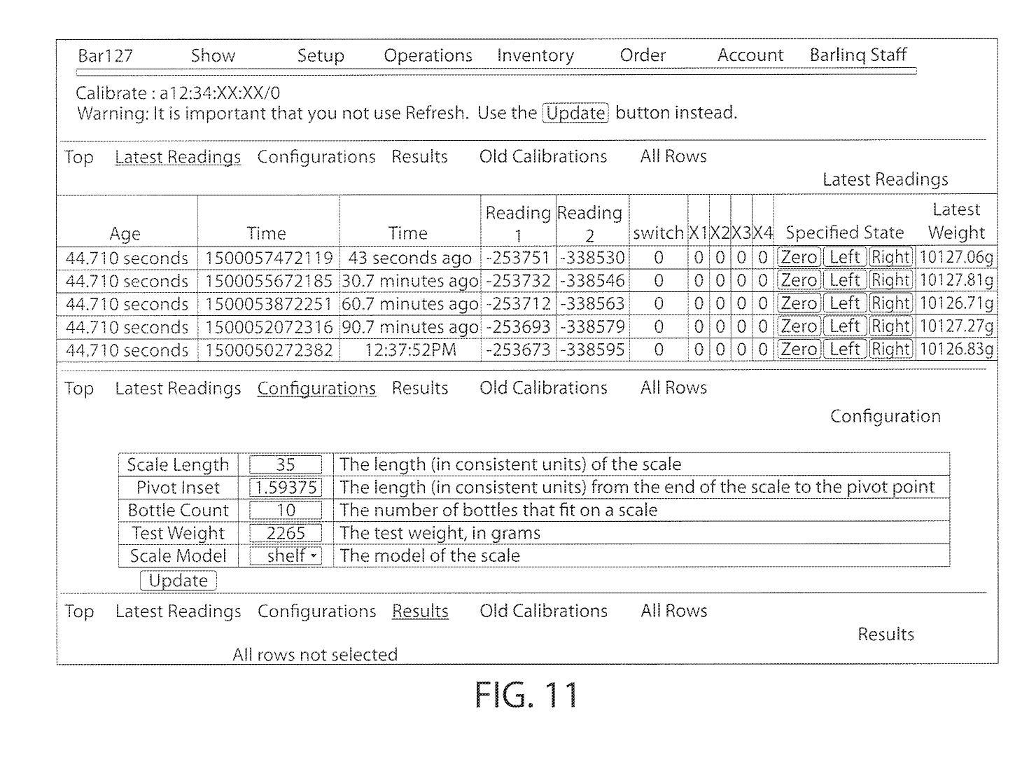

During operation, each scale assembly 102/104 provides raw load cell data (e.g., see FIG. 11) which shows a Reading 1 for scale assembly 102 and Reading 2 for scale assembly 104 for a particular shelf 100. Some filtering occurs in the electronic interface 108 such that the scale assemblies 102/104 do not “wake up” and transmit raw data to the base unit 24 unless a particular threshold is met; the requirement of meeting the threshold allows the system 20 to ignore changes in data caused from noise and vibration. As will be discussed below, each scale assembly 102/104 is calibrated for each shelf 100 and that calibration data is also passed on to the processor 28 for actual weight and bottle location calculations.

Mechanism for Detecting which, and how Much from the, Bottle that was Poured

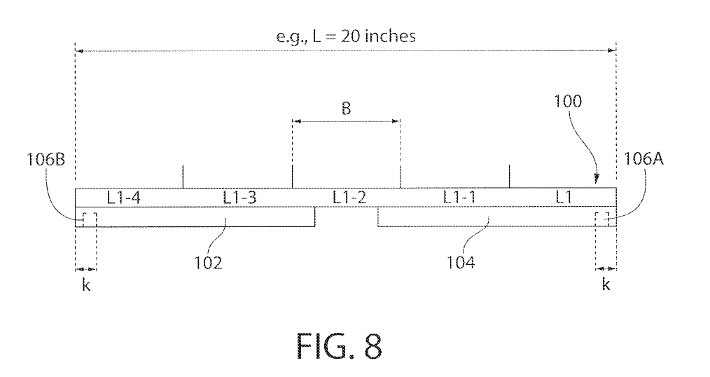

The processor 29 determines, for each shelf 100, how much of a particular bottle was poured out by detecting a change of weight in a bottle position on that particular shelf 10. As such, a particular liquor bottle is assigned to that bottle position. Bottle positions for a shelf are established based on the length of the shelf (L) divided by a bottle base width (B). Thus, for example, a shelf 100 of a 20″ length and assuming a bottle base of 3″-4″ yields a shelf 100 having 5 bottle positions. In general, the number of bottle positions is thus given by L/B. See FIG. 8. It is desirable to include indicia for bottle positions on the shelf 100 itself.

The load cells 106A/106B act as “pivot points” for the shelf 100 so when scale assemblies 102/104 are coupled to the opposite ends of the shelf 100, the load cells 106A/106B are positioned at a predetermined distance k (e.g., k<2″) from the shelf 100 ends (FIGS. 2 and 8). As a result, bottles placed on the shelf do not rest over the distance k.

The raw data from load cells 106A/106B of the two scale assemblies 102/104 are given by the terms R1 and R2, where R1 is the raw data from scale assembly 102 and R2 is the raw data from the scale assembly 104. The net weight (W) on the shelf 100 is a translational and rotational equilibrium equation given by:

W=R1·C1+R2·C2+C3,

where C1, C2 and C3 are constants determined by calibration, and where C3 represents the zero value for the shelf 100.

The change in weight (ΔW) of the shelf on any given event is:

ΔW=ΔR1·C1+ΔR2·C2;

The position (X) of a change-in-weight event is:

X=(ΔR2·C2·(L1−2·k1))/ΔR1·C1+ΔR2·C2)+k1−0.5

where L1 is defined by L/B; and k1 is defined as k/B. The value of X when calculated is rounded to the nearest integer (and typically bounded to the range of 0 to (k1−1)) to determine which bottle position is where the weight change occurred. It is ideal for the following limitation on k1, namely 0<k1<0.5.

The calibration information, namely, L1, k1, C1, C2, C3, and (for traceability and repeatability purposes) B, as well as the timestamps of three test readings. These are then associated with the communication hardware used for the scale assemblies 102/104.

The calibration is conducted by taking three test readings. The first test reading is conducted with an empty shelf 100. The second reading is taken with a known weight (e.g., a known weight corresponding to ½ the weight when the shelf is fully loaded) at one end of the shelf 100 and the third reading is taken with a known weight (e.g., a known weight corresponding to ½ the weight when the shelf is fully loaded) at the other end of the shelf 100. Entering this data into the net weight equation discussed previously results in three equations with three unknowns (C1, C2 and C3) which can be readily solved.

As mentioned previously, the shelf assembly 100 “wakes” up the base unit 24 only if a certain threshold is detected by the scales 102/104. Moreover, since the actual weight calculation is done in the processor 29, shelf assembly 100 wakes up the base unit 24 based on a threshold that is defined as:

IR1_{old}−R1_{new}|+|R2_{old}−R2_{new}|≥Threshold

By way of example, this threshold may comprise a value of 1000 which corresponds to 18.3 grams.
Thus, by placing different alcoholic beverage bottles (or other vessels) on the shelf 100, taking an overall shelf weight 100, and as long as any particular bottle is restored to its original position after being poured, the system 20 or 20A is able to make an accurate determination of the alcoholic beverage actually poured from a particular bottle at particular time.

It should be understood that the broadest scope of the invention includes the use of bottle positions of different sizes. This is accomplished by establishing bottle sizes individually and identifying the bottle position by finding the closest center other than through simple rounding. As a result, the B variable is eliminated from the equations above, while requiring the use of actual measurement units.

Measurement occurs whenever one of the objects is placed down on the shelf 100 or picked up. The changes cannot happen faster than weight measuring device (load cell) can read; this is typically several seconds. The load cells are linear are off by less than 0.1%. The design and implementation assume that each change in weight event completes before the next one starts. This means that a bar tender can't pick up one bottle at the same time that he/she restore another bottle. Due to the limitations of the load cells, it also means that the system 20 needs 3-5 seconds of separation between the events.

The following discussion regards several screen displays of the customer facing application (CFA) which can be provided on a computer terminal or monitor showing the data collected by the system of FIG. 1.

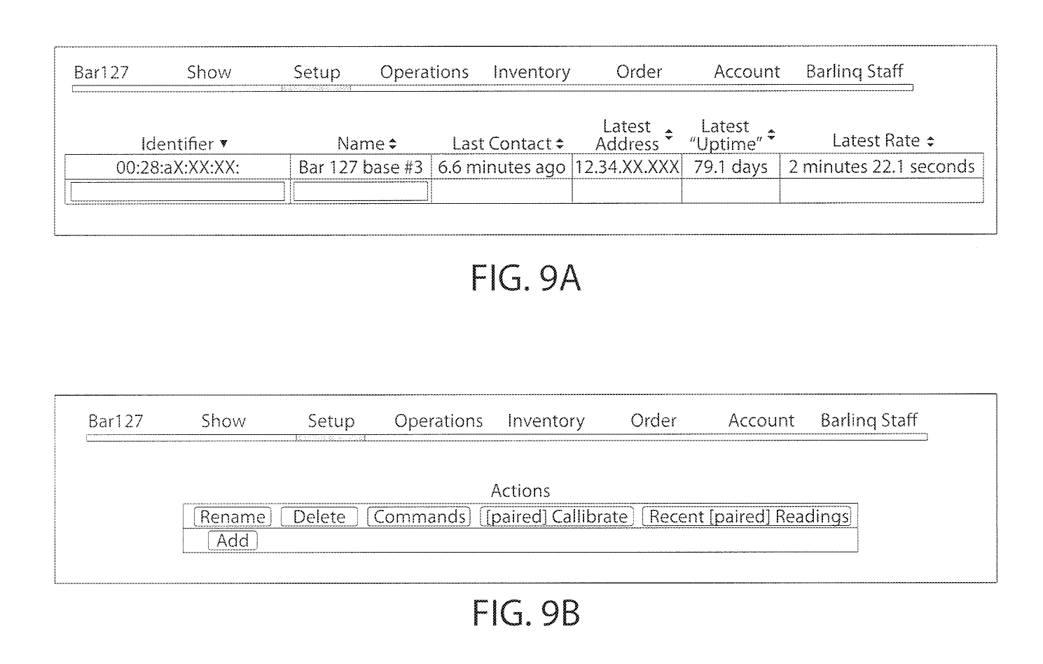

FIGS. 9A-9B together depict an exemplary base unit CFA display screen showing, among other things, the ID of the base unit.

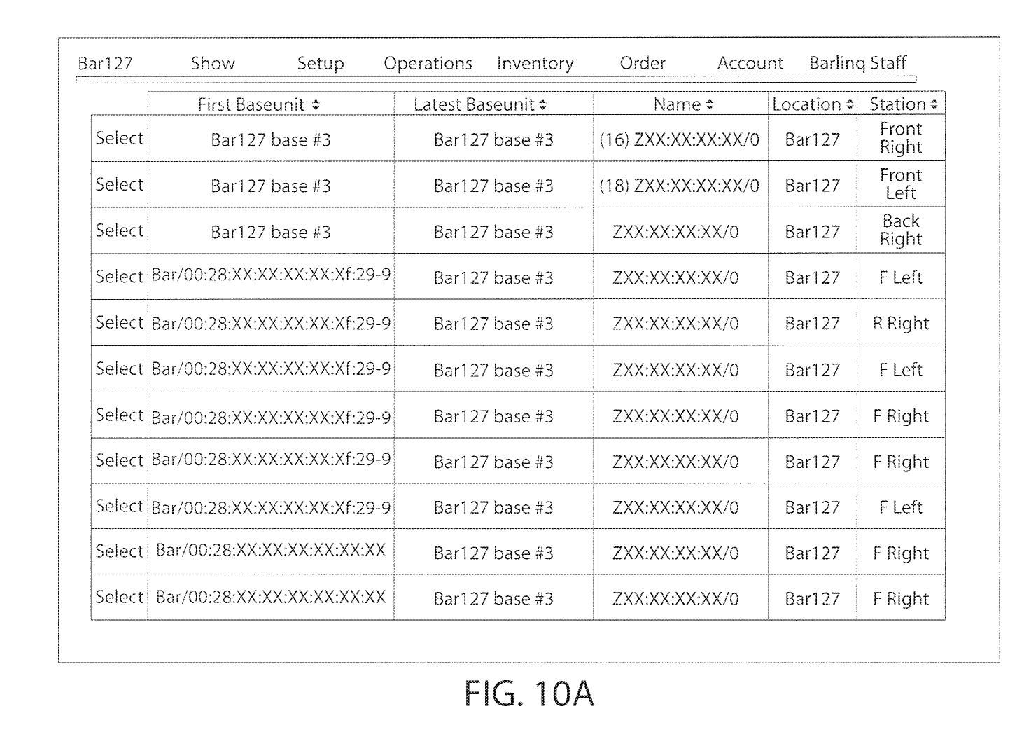

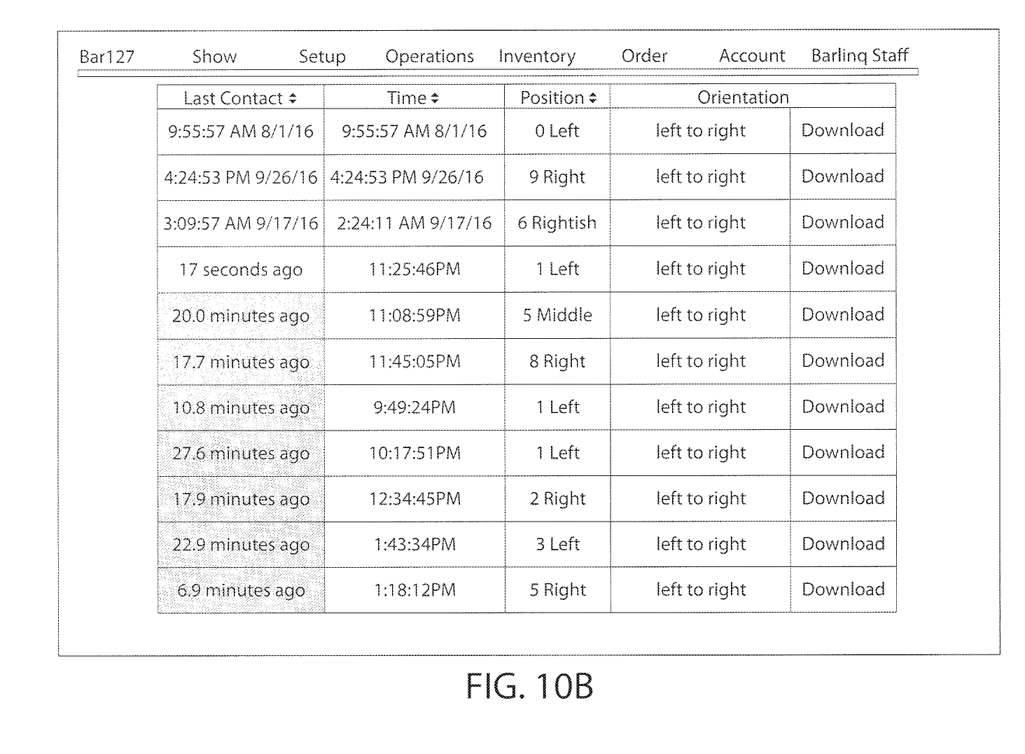

FIGS. 10A-10B together depict an exemplary CFA display screen of the roster of individual scale assemblies 102 and 104 with, among other things, the unique ID of each scale assembly.

FIG. 11 depicts the display screen of a particular shelf 100 namely, the shelf 100 having an ID of “a12:34:XX:XX/0” as shown in the upper left of this screen. As can be seen on the left side, among other things, the shelf length (35 inches) and the bottle count (10) are provided in this screen.

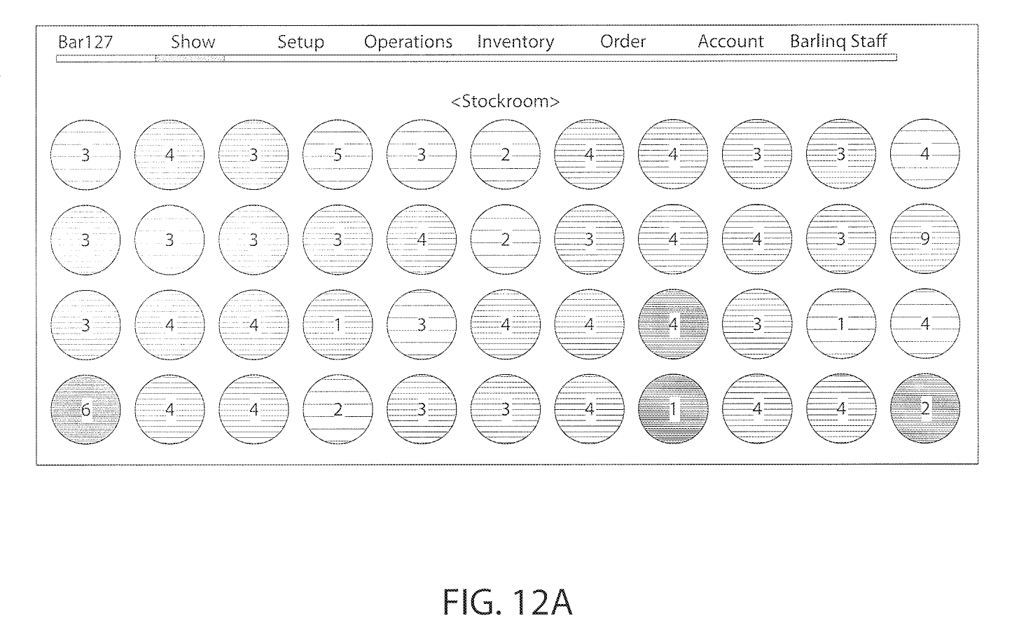

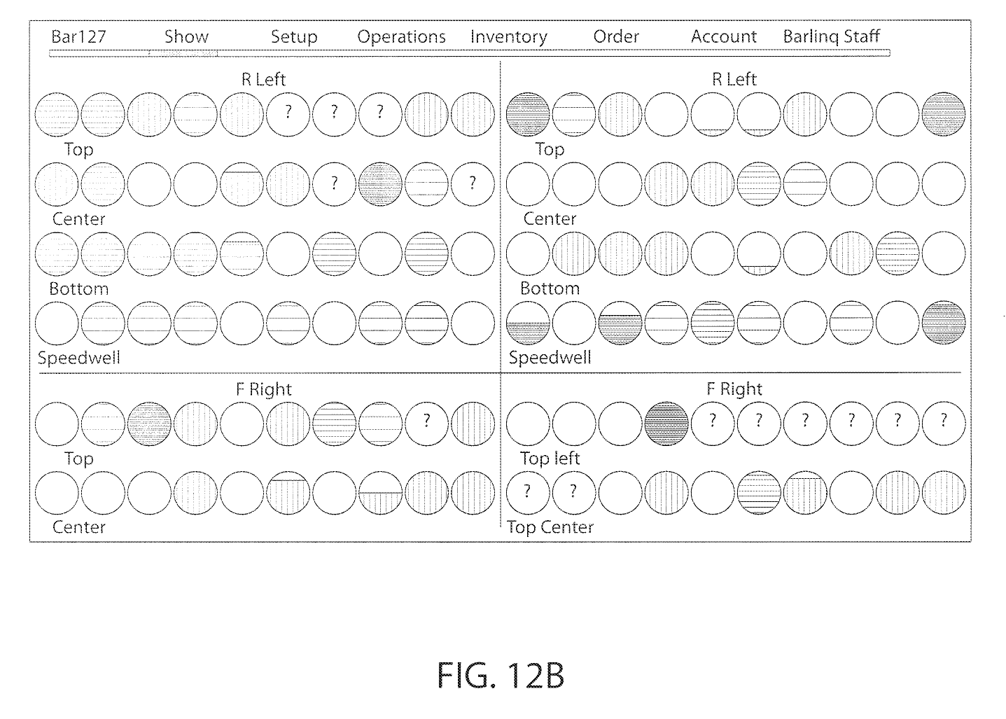

FIG. 12A shows the stockroom inventory by color and number associated with each circle, while FIG. 12B shows the distribution of the bottles on all of the shelves 100 in the establishment by color.

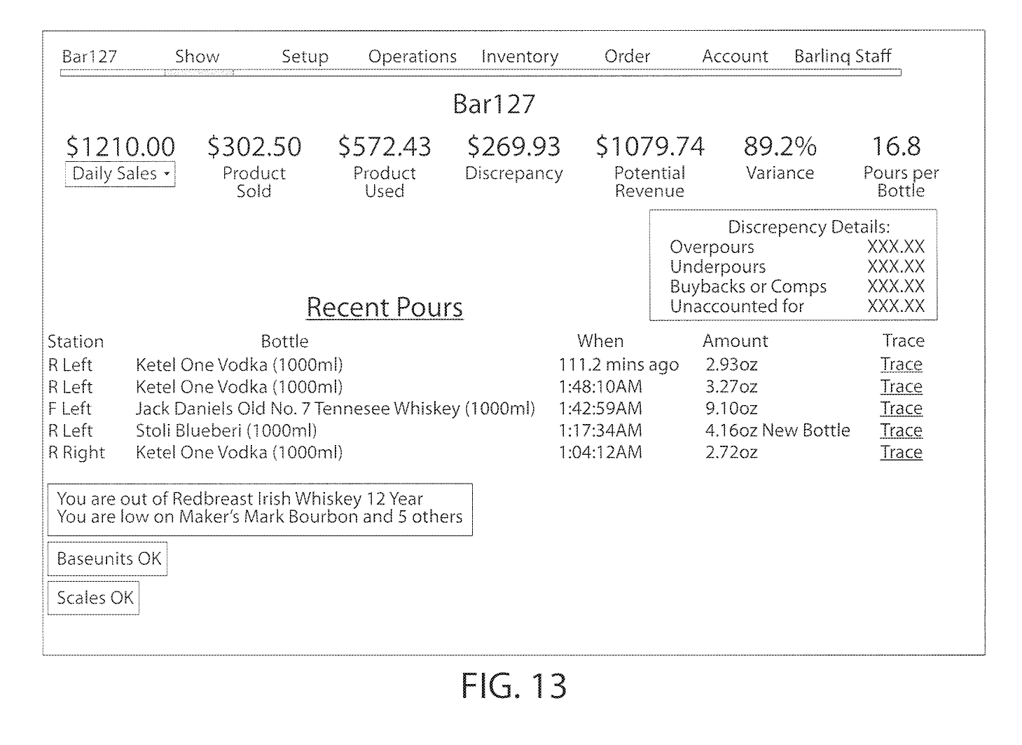

FIG. 13 shows an exemplary CFA dashboard which displays the costs and revenues associated with all of the shelves that form the invention. In particular, the $1210.00 value represents that day's sale receipts while the $302.50 represents the amount of liquor sold that day. The $572.43 represents the amount of liquor that was actually poured and the $269.93 represents the discrepancy in what was poured and what was paid for. The $1079.74 represents the potential revenue had the bar owner actually sold what was given away. This display screen also breaks down the discrepancy details on the far right of the screen while the details about the recent pours is provided on the left side of the display screen.

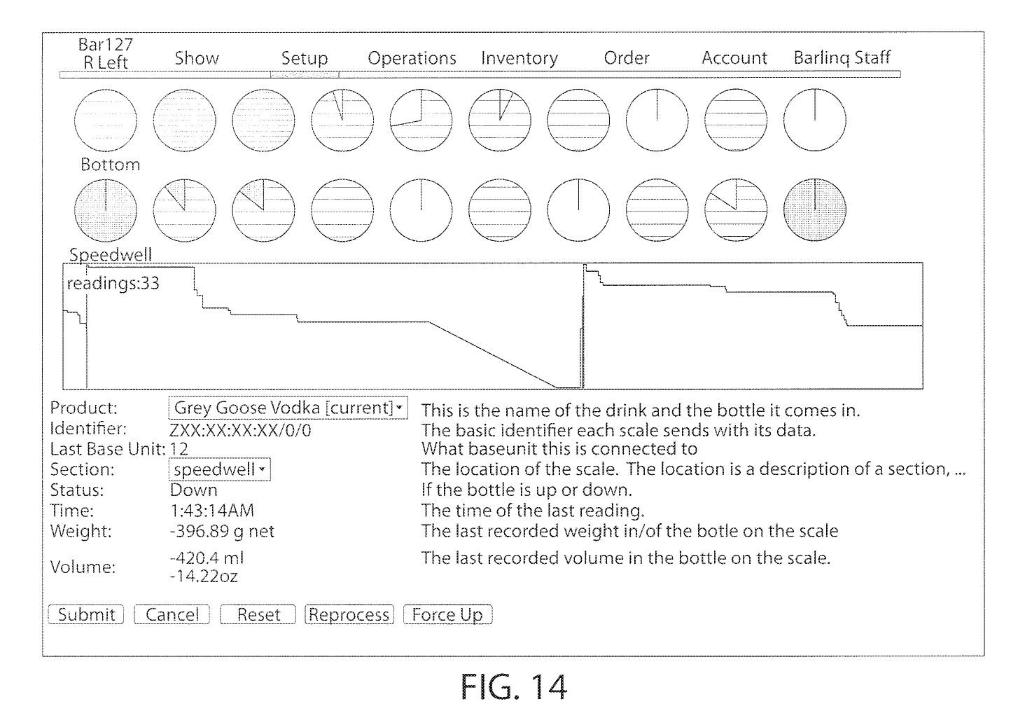

FIG. 14 depicts an exemplary CFA display screen for the bottle position assignment. Thus, the owner establishes what liquor bottle will occupy a particular space on a particular shelf 100. By way of example only, the farthest most left circle on the bottom shelf is assigned to Grey Goose Vodka. All of the removal/restoration events involving this position are provided in this display screen.

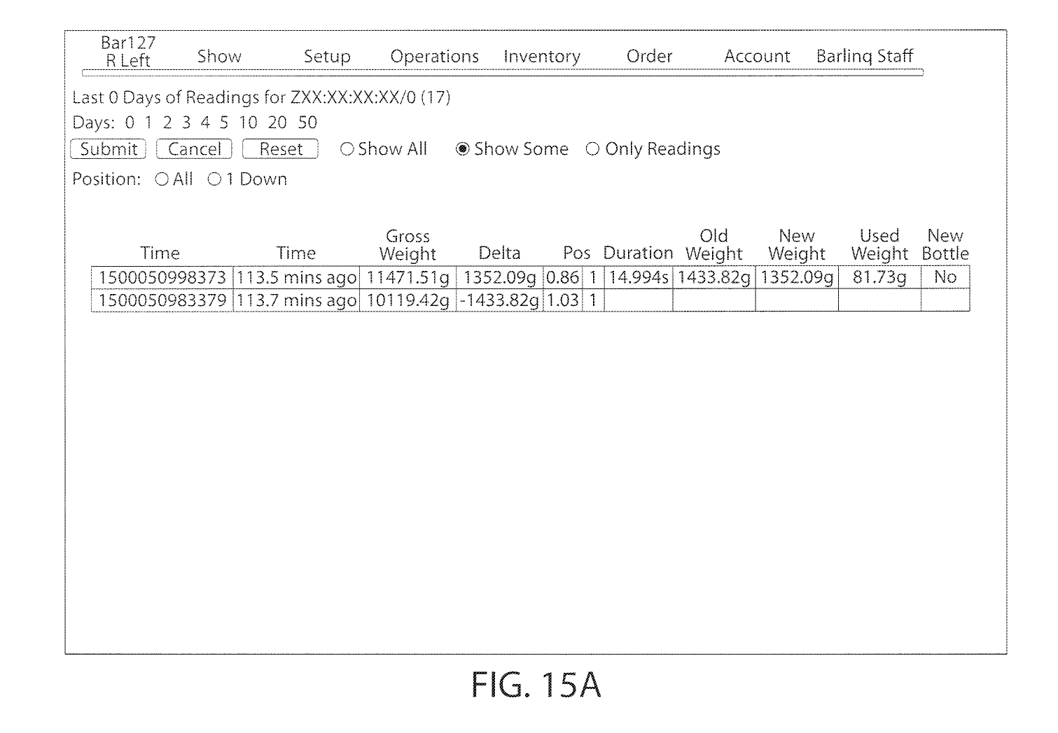

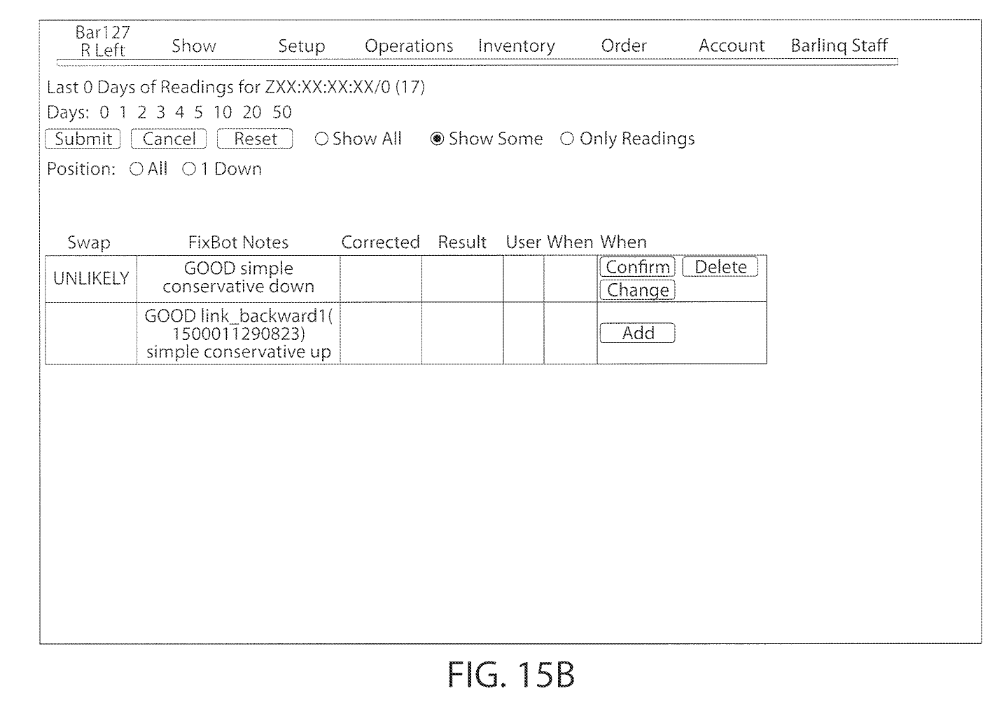

FIGS. 15A-15B depict an exemplary CFA display screen that provides a trace of a bottle picked up, poured and then restored to its position. In particular, the most recent time stamp is provided at the top of the chart. Thus, by way of example only, in the lower row entries, at 113.7 minutes prior to this screen display time, the bottle at position 1 was picked up causing a ΔW in the shelf 100 of −1433.82 grams. At 0.2 minutes later, the bottle at position 1 was restored and the system detected a ΔW of 1352.09 grams. As a result, 81.73 grams of the position 1 bottle was poured.

It should be pointed out at this juncture that the system as described above is merely exemplary of various systems that can be constructed in accordance with the teaching of this invention.

Without further elaboration the foregoing will so fully illustrate our invention that others may, by applying current or future knowledge, adopt the same for use under various conditions of service.

We claim:

1. An alcoholic beverage inventory management system for use in a business establishment where alcoholic beverages are dispensed, said system comprising:
at least one shelf upon which are positioned bottles or other vessels for holding alcoholic beverages, said shelf having two opposite ends and a respective scale positioned under each end, each of said scales providing load data of the bottles or other vessels positioned on said at least one shelf to a base unit over a first communication system;
a system database for storing said load data received from said base unit;
a processor in communication with said system database, said processor analyzing said load data for determining the amount of liquor dispensed from respective bottles on said at least one shelf;
a point of sale system associated with the business establishment which provides data related to the sale of alcoholic beverages in the business establishment to said system database for analysis by said processor; and
a computer, comprising a software application, that is in communication with said processor, said computer displaying data related to revenues and costs associated with the alcoholic beverages dispensed from the bottles or other vessels on said at least one shelf.

2. The system of claim 1 wherein said processor comprises remotely-located processing via global computer networks and wherein said system further comprises a second communication system for communicating said load data between said base unit and said system database via global computer networks;

3. The system of claim 1 wherein each of said scales comprises load cells that detect the load on the at least one shelf.

4. The system of claim 1 wherein said first communication system comprises a wired communication system between each of said scales and said base unit.

5. The system of claim 1 wherein each of said scales comprises a radio frequency (RF) module for wirelessly transmitting its respective load data to said base unit.

6. The system of claim 1 wherein each shelf comprises a radio frequency (RF) module and wherein each of said scales communicates with said RF module.

7. The system of claim 1 wherein said processor uses said load data to determine a change of weight of said at least one shelf when a bottle or other vessel is removed from said at least one shelf and then returned to said at least one shelf.

8. The system of claim 7 wherein said processor uses said load data to determine which bottle or other vessel on said at least one shelf was removed and restored.

9. The system of claim 8 wherein said load data further includes calibration data for each of said scales associated with said at least one shelf.

10. The system of claim 9 wherein said processor uses the following relationship to determine said change of weight (ΔW):
ΔW=ΔR1·C1+ΔR2·C2,
wherein ΔR1 represents a change in an electronic output of one of said scales;
wherein ΔR2 represents a change in an electronic output of the other one of said scales; and
wherein C1 and C2 represent respective calibration data for each of said scales.

11. The system of claim 10 wherein said processor uses the following relationship to determine which bottle or other vessel on said shelf was removed and restored:
X=(ΔR2·C2·(L1−2·k1))/ΔR1·C1+ΔR2·C2)+k1−0.5,
wherein X represents a position on said shelf where said bottle or other vessel was removed and restored to;
wherein L1 represents a ratio of a length said at least one shelf divided by a width of said bottle or other vessel; and
wherein k1 represents a ratio of a distance from an end of said at least one shelf to where at least one load cell in one of said scales is positioned divided by said width of said bottle or other vessel.

12. The system of claim 11 wherein said processor only determines ΔW and X, if a sum of said scale electronic outputs exceeds a predetermined threshold.

13. The system of claim 1 wherein said computer comprises any one from the group of workstation, laptop and smartphone.

14. The system of claim 13 wherein said system database comprises an inventory of all bottles or other vessels in said business establishment.

15. The system of claim 14 wherein said software application forms a plurality of spreadsheets for displaying weight data and bottle or other vessel data pertaining to said at least one shelf.

16. The system of claim 14 wherein said wherein said bottle or other vessel data comprises pour events from said bottle or other vessel data.

17. The system of claim 14 wherein said bottle or other vessel data comprise data relating to product sold in dollars, product used in dollars, any discrepancy in dollars based upon a difference in said product used in dollars and said product sold in dollars.

18. A method for managing alcoholic beverage inventory in a business establishment where alcoholic beverages are dispensed, said method comprises:
positioning a scale under a respective end of at least one shelf upon which are placed bottles or other vessels for holding alcoholic beverages, each of said scales providing load data about the bottles or other vessels positioned on said at least one shelf to a base unit over a first communication system;
providing a system database for storing said load data received from said base unit and providing a processor in communication with said system database;
analyzing said load data by said processor for determining the amount of alcoholic beverages dispensed from respective bottles on said at least one shelf;
providing data, from a business establishment point of sale system, related to the sale of alcoholic beverages in the business establishment to said processor; and
displaying, on a computer comprising a software application which is in communication with said processor, data related to revenues and costs associated with the alcoholic beverages dispensed from the bottles or other vessels on said at least one shelf.

19. The method of claim 18 wherein said step of providing a processor comprises utilizing remotely-located processing via global computer networks, said method further comprising communicating, using a second communication system, said load data between said base unit and said system database via global computer networks.

20. The method of claim 18 wherein each of said scales comprises load cells that detect the load on said at least one shelf.

21. The method of claim 18 wherein said first communication system comprises a wired communication system between each of said scales and said base unit.

22. The method of claim 18 wherein each of said scales comprises a radio frequency (RF) module for wirelessly transmitting its respective load data to said base unit.

23. The method of claim 18 wherein each shelf comprises a radio frequency (RF) module and wherein each of said scales communicates with said RF module.

24. The method of claim 18 wherein said step of analyzing said load data comprises determining a change of weight of said at least one shelf when a bottle or other vessel is removed from said at least one shelf and then returned to said at least one shelf.

25. The method of claim 24 wherein said step of analyzing said load data comprises determining which bottle or other vessel on said at least one shelf was removed and restored.

26. The method of claim 25 wherein said load data further includes calibration data for each of said scales associated with said at least one shelf.

27. The method of claim 26 wherein said processor uses the following relationship to determine said change of weight (ΔW):
ΔW=ΔR1·C1+ΔR2·C2,
wherein ΔR1 represents a change in an electronic output of one of said scales;
wherein ΔR2 represents a change in an electronic output of the other one of said scales; and
wherein C1 and C2 represent respective calibration data for each of said scales.

28. The method of claim 27 wherein said processor uses the following relationship to determine which bottle or other vessel on said shelf was removed and restored:
X=(ΔR2·C2·(L1−2·k1))/ΔR1·C1+ΔR2·C2)+k1−0.5,
wherein X represents a position on said shelf where said bottle or other vessel was removed and restored to;
wherein L1 represents a ratio of a length said at least one shelf divided by a width of said bottle or other vessel; and
wherein k1 represents a ratio of a distance from an end of said at least one shelf to where at least one load cell in one of said scales is positioned divided by said width of said bottle or other vessel.

29. The method of claim 28 wherein said processor only determines ΔW and X, if a sum of said scale electronic outputs exceeds a predetermined threshold.

30. The method of claim 18 wherein said computer comprises any one from the group of workstation, laptop, and smartphone.

31. The method of claim 28 wherein said system database comprises an inventory of all bottles or other vessels in said business establishment.

32. The method of claim 31 wherein said step of displaying comprises forming a plurality of spreadsheets for displaying weight data and bottle or other vessel data pertaining to said at least one shelf.

33. The method of claim 32 wherein said step of displaying comprises displaying pour events from said bottle or other vessel data.

34. The method of claim 33 wherein said step of displaying comprises displaying data relating to product sold in dollars, product used in dollars, any discrepancy in dollars based upon a difference in said product used in dollars and said product sold in dollars.
